(19) United States
(12) Patent Application Publication
(10) Pub. No.: US 2006/0209049 A1
(43) Pub. Date: Sep. 21, 2006

(54) Operation panel and method of controlling display thereof

(75) Inventor: Yoko Tanaka, Osaka (JP)

Correspondence Address: OSTROLENK FABER GERB & SOFFEN, 1180 AVENUE OF THE AMERICAS, NEW YORK, NY, 100368403, US

(73) Assignee: Kyocera Mita Corporation

(21) Appl. No.: 11/369,498

(22) Filed: Mar. 7, 2006

(30) Foreign Application Priority Data
Mar. 16, 2005 (JP) P2005-074802

(51) Int. Cl. G09G 5/00

(52) U.S. Cl. 345/173

(57) ABSTRACT

An operation panel which is applicable to an electronic device includes: a display having a plurality of display regions; a plurality of operating buttons connected to the display regions; a plurality of lights which illuminate the display regions; a timer which is adapted to detect whether or not a predetermined period has passed after any of the operating buttons is operated; and a control unit which is adapted to turn off or darken the lights in series each time the timer detects a passage of the predetermined period.

### BACKGROUND OF THE INVENTION

1. Field of the Invention

The present invention relates to an operation panel which is applicable to electronic devices and a method for controlling the display of the operation panel.

Priority is claimed on Japanese Patent Application No. 2005-74802, filed Mar. 16, 2005, the content of which is incorporated herein by reference.

2. Description of Related Art

In electronic devices, an operation panel is generally provided having a plurality of operating buttons performing for various kinds of operations. The operation panel is normally lit by a backlight at a predetermined illuminance. Several technologies to adjust the illuminance of an operation panel in accordance with illumination around the device have been disclosed (see Japanese Unexamined Patent Application, First Publications No. 2001-60080 and No. 2004-202759).

However, adjustments of the illuminance of the operation panel disclosed in the above publications only depend on a factor which is outside the electronic device such as an illumination condition around the electronic device. Since these technologies do not adjust the illuminance in accordance with information about the electronic device itself, users may feel inconvenience in operation, for example, when using the electronic device in a dark room. In addition, there is a problem in that the electronic device wastes energy because the illuminance of the operation panel does not change until the illumination condition changes even though the electronic device is not operated for a predetermined period.

### SUMMARY OF THE INVENTION

The present invention has an object to provide an operation panel and a method of controlling a display thereof which are adapted to controlling the size of an illuminated area in accordance with an operating condition.

The first aspect of the present invention is an operation panel which is applicable to an electronic device including: a display having a plurality of display regions; a plurality of operating buttons connected to the display regions; a plurality of lights which illuminate the display regions; a timer which is adapted to detect whether or not a predetermined period has passed after any of the operating buttons is operated; and a control unit which is adapted to turn off or darken the lights in series each time the timer detects a passage of the predetermined period.

The second aspect of the present invention is a method of controlling display of an operation panel which is applicable to an electronic device, the operation panel including: a display having a plurality of display regions; a plurality of operating buttons connected to the display regions; and a plurality of lights which illuminate the display regions, the method including: a first step of displaying information on the display; a second step of measuring elapsed time after any of the operating buttons is operated; and a third step of turning off or darkening the lights in series each time the elapsed time reaches a predetermined period.

Since the present invention controls the size of a display area or illuminated area based on the operating condition of the operation panel, a display which is suitable for the user's condition can be provided. In addition, frequent control of the size of the display area and illumination contributes to suppressing energy consumption.

### BRIEF DESCRIPTION OF THE DRAWINGS

FIG. 1 is a drawing showing an operation panel of a first embodiment of the present invention.

FIG. 2 is a block diagram showing a display control unit of an electronic device to which the operation panel of the present invention is applied.

FIG. 3 is an explanatory drawing showing a condition in which an illumination of one display region is turned off.

FIG. 4 is a flowchart showing a process of the control of the display.

FIG. 5 is a drawing showing an operation panel of a second embodiment of the present invention.

### DETAILED DESCRIPTION OF THE INVENTION

Embodiments of the present invention are described hereinbelow with reference to the drawings. In this embodiment, a display area of the operation panel is reduced when a predetermined period has passed after a user operates the operation panel.

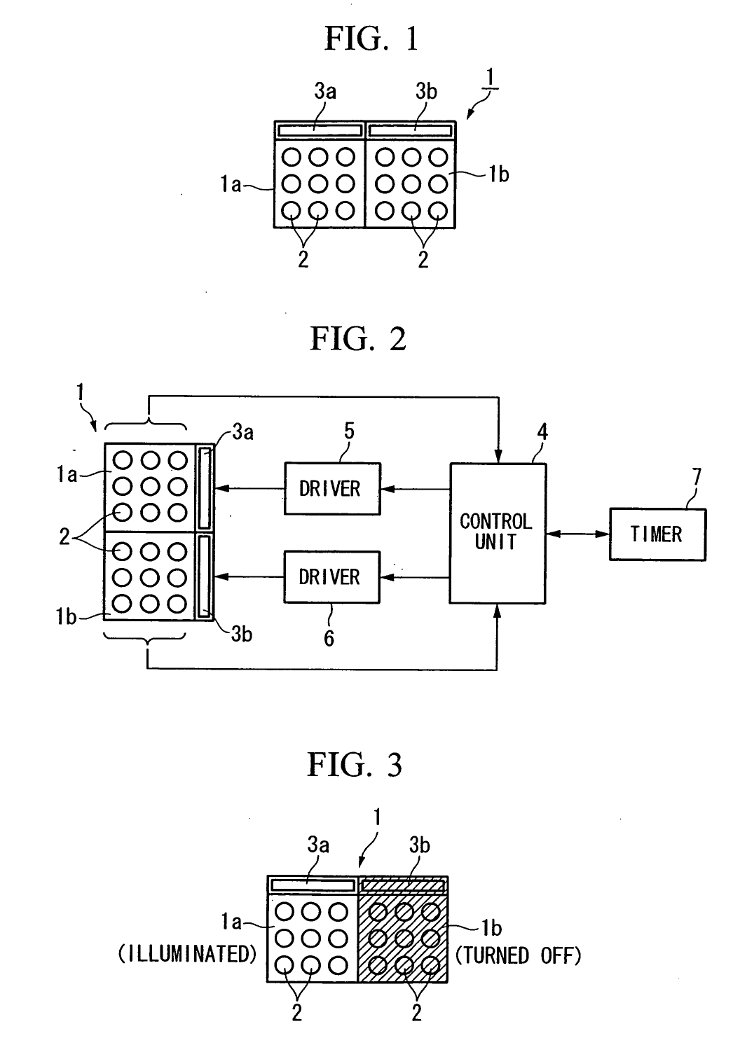

FIG. 1 is a block diagram generally showing an operation panel of a first embodiment of the present invention. In FIG. 1, an operation panel 1 has a display having liquid crystal display (LCD). The display is divided into two display regions, 1a and 1b. Each display region has a plurality of operating buttons 2 (touch switches). The operating buttons 2 provided on the display region 1a, for example, are major buttons which are frequently used, and the operating buttons 2 provided on the display region 1b are minor buttons which are not so frequently used.

In addition, backlights 3a and 3b which illuminate the respective display regions 1a and 1b are provided on the edge of a substrate of the operation panel 1. The light emitted from the backlights 3a and 3b illuminates the display through a light guide panel (not illustrated) provided on the substrate of the operation panel 1. Since the operation panel 1 and the backlights 3a and 3b have an already known structure for attachment, a detailed explanation is omitted.

FIG. 2 is a block diagram showing a display control unit of the operation panel 1 of the electronic device. The same reference numerals are provided for the elements which are identical to the elements shown in FIG. 1 and explanations thereof are omitted. In FIG. 2, drivers 5 and 6 controls the backlights 3a and 3b of the operation panel 1. The drivers 5 and 6 are controlled by a control unit 4. When any one of the operation buttons 2 is operated, the control unit 4 starts a timer 7 and measures an elapsed time.

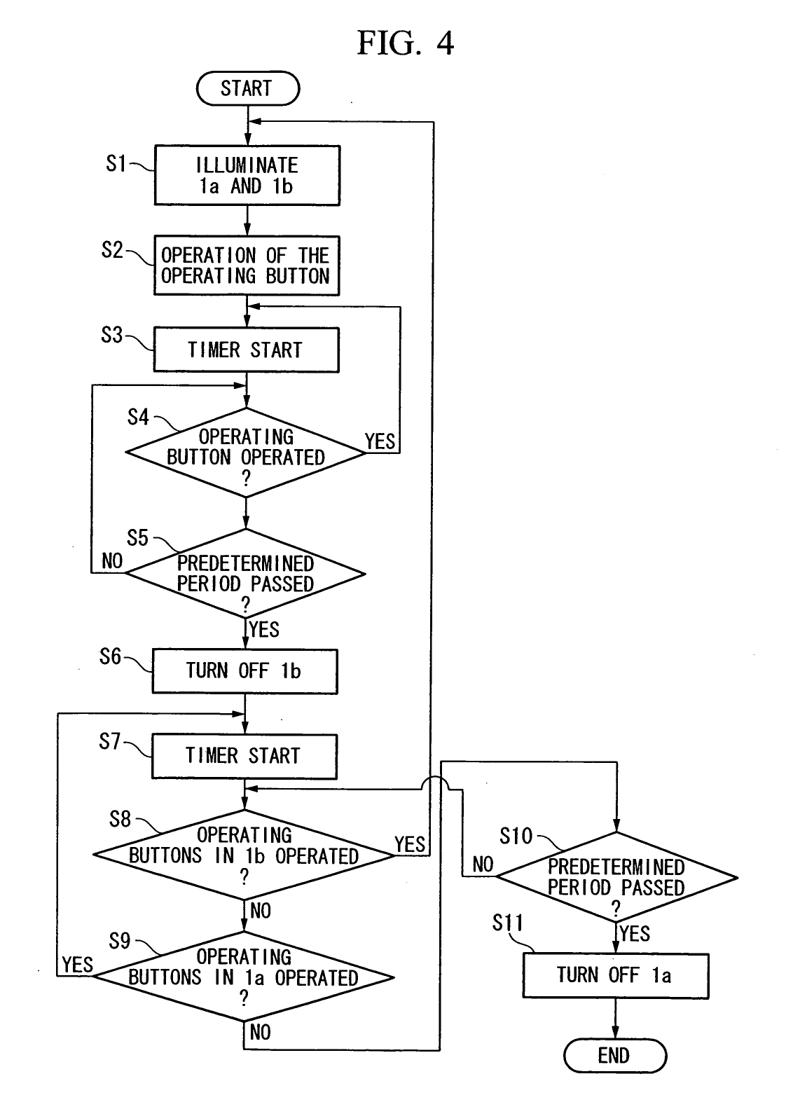

Next, the processing carried out by the above structure is described with reference to FIG. 4. In a state in which the electronic device is in operation and the display regions 1a and 1b are illuminated (this means that the backlights 3a and 3b are lit herein below) (step S1), when any one of the operation buttons 2 provided in the display regions 1a and 1b (step S2) is operated, the control unit 4 makes the timer 7 start (step S3). While the timer 7 measures the elapsed time, the display regions 1a and 1b are illuminated. When any one of the operation buttons 2 is operated (YES in step S4), the process returns to step S3 and the timer 7 restarts.

When a predetermined period has passed without further operation (YES in step S5), the display region 1b is turned off. At this time, the operation panel 1 is like the one shown in FIG. 3 (step S6). Then the timer 7 starts (step S7). While the timer 7 measures the elapsed time, only the display region 1a is illuminated as shown in FIG. 3. When the operation button 2 of the display region 1b is operated (YES in step S8), the process returns to step S1 and the display region 1b is illuminated again. When the operation button 2 of the display region 1a is operated (YES in step S9), the process returns to step S7 and the timer 7 restarts. When a predetermined period has passed without further operation (YES in step S10), the display region 1a is turned off (step S11).

As described above, the display regions are reduced when a predetermined period has passed without the user's further operation in this embodiment. Therefore, energy consumption can be saved based on the operating condition of the electronic device, regardless of the surroundings thereof.

In this embodiment, although the display regions are adapted to be turned off when a predetermined period has passed without further operation, the display regions may be adapted to be darkened in the aforementioned condition. In addition, although the predetermined period is the same in step S5 and step S10 in FIG. 4, different periods may be respectively set in these steps. Furthermore, the predetermined period may be set by the user.

Next, a second embodiment of the present invention is described. This embodiment shows an image forming device such as a copying machine to which the present invention is applied.

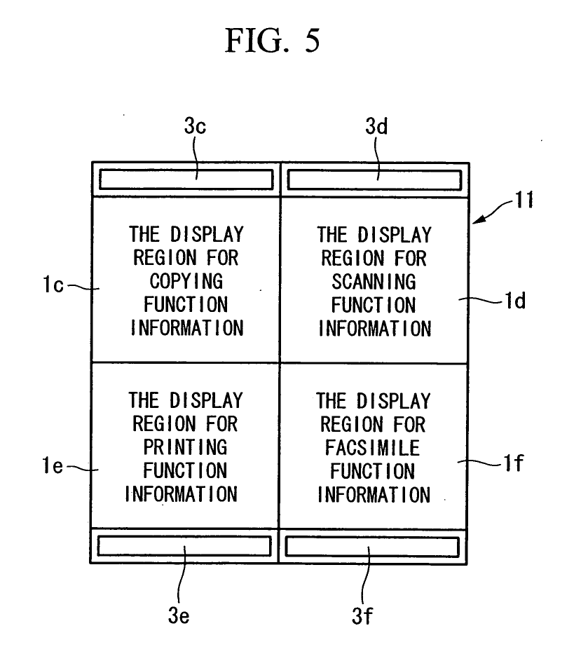

FIG. 5 is a drawing which shows a display of an operation panel 11. The display is divided into four display regions: a display region for copying function information 1c, a display region for scanning function information 1d, a display region for printing function information 1e, and a display region for facsimile function information If. Backlights 3c, 3d, 3e, and 3f are also provided in the operation panel 11. Backlights 3c, 3d, 3e, and 3f illuminates display regions 1c, 1d, 1e, and 1f, respectively.

In this embodiment, the display is reduced when a predetermined period has passed after a user operates any one of the operating buttons of the operation panel without further operation, the same as in the first embodiment. Specifically, the image forming device stops power supply to a printer engine unit and shifts to an energy-saving mode when the predetermined period has passed. At the same time, the display region for copying function information 1c, and the display region for printing function information 1e are turned off. The display region for scanning function information 1d, and the display region for facsimile function information 1f are turned off in series as the predetermined period has passed. Although the operating buttons are provided outside the operation panel 1l in this embodiment, they may be provided in each display region.

The display region for printing function information 1e may be adapted to be turned off (or be darkened) usually, regardless of whether the device is in energy-saving mode or not, and to be illuminated only when receiving print datum and printing.

The display region for facsimile function information If may be adapted to be turned off (or be darkened) usually, and to be illuminated only when receiving and printing facsimile datum. It may also be adapted to be illuminated and stop energy-saving mode by touching the display region when sending a facsimile.

In addition, the display region for copying function information 1c and the display region for scanning function information 1d may also be adapted to be illuminated and stop the energy-saving mode by touching each display region when operating.

Furthermore, in a case where literal notation is used in each display region 1c, 1d, 1e, and 1f, information may be displayed in a reduced state in the illuminated display regions when the display is reduced by turning off some of the display regions.

This embodiment makes it possible to provide a display condition based on actual operation of the operation panel to the user of the image forming device. In addition, energy consumption can be saved by reducing illumination of the operation panel.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. An operation panel which is applicable to an electronic device, comprising:
a display having a plurality of display regions;
a plurality of operating buttons connected to the display regions;
a plurality of lights illuminating the display regions;
a timer adapted to detect whether or not a predetermined period has passed after any of the operating buttons is operated; and
a control unit adapted to turn off or darken the lights in series each time the timer detects a passage of the predetermined period.

2. The operation panel according to claim 1, wherein information about functions of the electronic device is displayed on the display regions.

3. The operation panel according to claim 2, wherein when some of the lights are turned off, the information about functions is displayed in a reduced size on the display region which is illuminated by the rest of the lights.

4. The operation panel according to claim 1, wherein the timer is adapted to detect passages of a plurality of lengths of time.

5. The operation panel according to claim 1, further comprising:
a setting unit operable by a user to set the predetermined period to be detected by the timer based on an order of a user.

6. A method of controlling display of an operation panel which is applicable to an electronic device, the operation panel comprising: a display having a plurality of display regions; a plurality of operating buttons connected to the display regions; and a plurality of lights which illuminate the display regions, the method comprising:
a first step of displaying information on the display;
a second step of measuring elapsed time after any of the operating buttons is operated; and
a third step of turning off or darkening the lights in series each time the elapsed time reaches a predetermined period.

7. The method of controlling a display according to claim 6, wherein information about functions of the electronic device is displayed in the first step.

8. The method of controlling a display according to claim 7, wherein when some of the lights are turned off in the third step, the information about functions is displayed on the display region which is illuminated by the rest of the lights, achieving downsizing.

9. The method of controlling a display according to claim 6, wherein a plurality of lengths of time is set as the predetermined period to turn off or darken the lights in the third step.

10. The method of controlling display according to claim 6, wherein the predetermined period is set by a user.
